(19) United States
(12) Patent Application Publication
(10) Pub. No.: US 2022/0282535 A1
(43) Pub. Date: Sep. 8, 2022

(54) QUARTER TURN TWIST LOCK DOOR LATCH

(71) Applicant: RON ZEITLER, SAGINAW, MI (US)

(72) Inventor: RON ZEITLER, SAGINAW, MI (US)

(21) Appl. No.: 17/804,332

(22) Filed: May 27, 2022

Related U.S. Application Data
(63) Continuation-in-part of application No. 16/538,993, filed on Aug. 13, 2019.

(51) Int. Cl. E05C 3/04; E05B 9/08

(52) U.S. Cl. CPC E05C 3/042; E05B 9/08

(57) ABSTRACT

A quarter turn twist lock door latch.

### CROSS-REFERENCE TO RELATED APPLICATIONS

This application is a continuation-in-part of U.S. Utility patent application Ser. No. 16/538,993, filed Aug. 13, 2019, from which priority is claimed.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Applicant is aware of two prior publications dealing with quarter turn fasteners. U.S. Pat. No. 4,657,462 that issued to Hoen on Apr. 14, 1987, deals with a quarter turn fastener assembly in which two panels are fastening together by inserting a nose portion through a slot hole in a second panel and the fastener turn head is rotated a quarter turn.

A second patent, U.S. Pat. No. 5,630,632 that issued on May 20, 1997, to Swan deals with quarter turn latch which consists of a latching member connected to an actuating member that are snapped together.

### BRIEF SUMMARY OF THE INVENTION

The present invention is a quarter turn twist lock door latch. The quarter turn twist lock door latch comprises in combination, a latch, a quarter turn twist lock door latch that has a front opening, a center core, a cross slot in a front of the center core and a latch extension extending from the latch.

The latch has a back edge. The latch has a lock block mounted on the back edge. The lock is insertable in the opening of the latch and is turnable therein.

There is also a lock for the latch. There is also a rubber O-ring surrounding the center core at a distal end of the center core.

### BRIEF DESCRIPTION OF THE SEVERAL VIEWS OF THE DRAWING(S)

FIG. 1 is an illustration of a device of this invention in expanded form through the wall of a door.

FIG. 2 is a full front view of the latch of this invention.

FIG. 3 is a full side view of the latch of FIG. 2.

FIG. 4 section B-B is a full section side view of the latch of FIG. 2.

FIG. 5 is a full top view of the lock block of FIG. 2.

FIG. 6 is a full bottom view of the center core.

FIG. 7 is a full side view of the center core of FIG. 6.

FIG. 8 is a full front view of the center core of FIG. 6.

FIG. 9 Section C-C is a full section side view of the latch of FIG. 2.

FIG. 10 is a full back view of FIG. 2.

FIG. 11 is an illustration of the device installed in a door.

### DETAILED DESCRIPTION OF THE INVENTION AND DRAWINGS

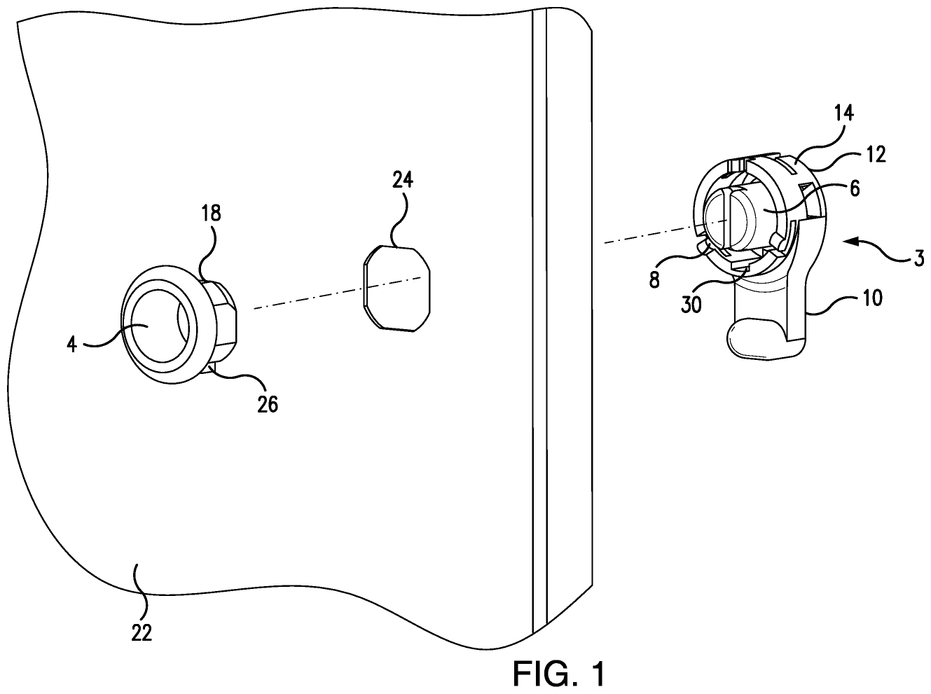

T FIG. 1 is an illustration of a device 2 of this invention in expanded form. The quarter turn twist lock door latch or device 2 has a first opening 4, a centered core 6, a cross slot 8 and a latch extension 10. The quarter turn twist lock door latch 2 also has a back edge 12, a lock block 14, a lock 18 and an O-ring 20.

The quarter turn twist lock door latch 2 has a lock 18 that is exterior to a door 22, for example. The door 22 has an opening 24 that receives the lock 18. The lock 18 passes through the opening 24 and inserts into the latch 3 of the device 2. The lock 18 is then inserted over the center core 6 and into the lock block 14. There is a lock tab 26 on the bottom of the lock 18 that passes through the door opening and 24 and inserts into keyway 30 of lock block 14. The device 2 is operated by rotating the cross slot 8 of the center core 6 180 degrees until lock tab 26 locks behind lock retainer 29 and retaining channel 31, thus locking lock 18 and latch 3 together, limiting rotation to quarter of a turn and allowing the latch to rotate in door 22 to latch or unlatch the door.

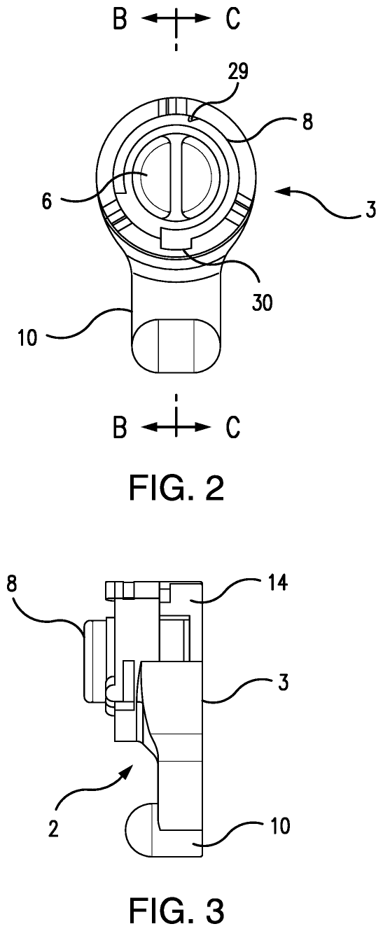

FIG. 2 is a full front view of the latch 3 of this invention. The latch 3 consists of the latch extension 10, center core 6, the lock block 14 and the cross slot 8.

FIG. 3 is a full side view cross sectional of the latch 3 of FIG. 2.

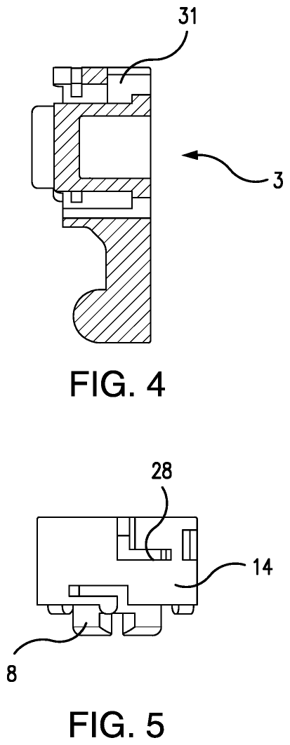

FIG. 4 is a full sectional side view of the latch 3 of

FIG. 3. The center core 6 rotates one quarter turn inside the latch 3. It also rides on the lock block 14. Also shown is the lock extension 10.

FIG. 5 is a full top view of the lock block 14 of FIG. 2. The lock 18 inserts over the center core 6 and the lock block 14 and will rotate over the center core 6 and will lock into the lock block 14 at a quarter turn.

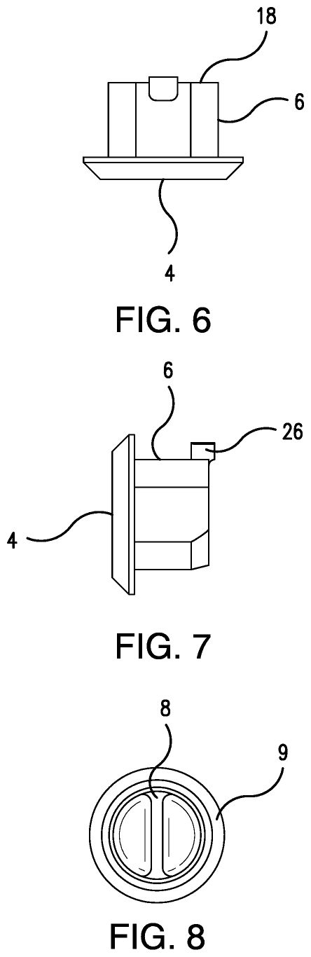

FIG. 6 is as full bottom view of the center core 6. The front opening 4 is designed to insert over the lock block 14. The center core 6 has a lock 18 protruding from the bottom. This lock fits into the lock block 14 L-shaped section 28. This L-shaped section 28 allows the lock 18 to rotate within the lock block 14 and locking at one quarter turn.

FIG. 7 is a full side view of the center core 6 of device 2.

FIG. 8 is a full front view of the center core of FIG. 6. Shown here is the cross slot 8 and the center core 8.

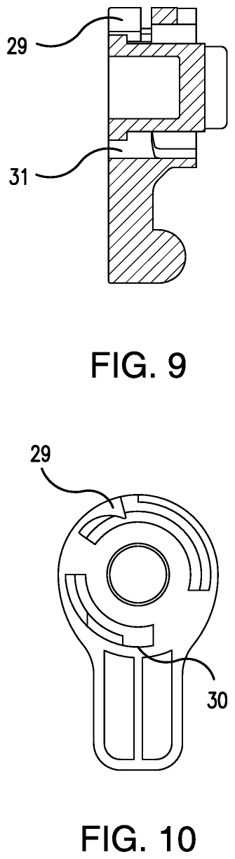

FIG. 9 is a full section side view of the latch of FIG. 2 and FIG. 10 is a full back view of the device of FIG. 2.

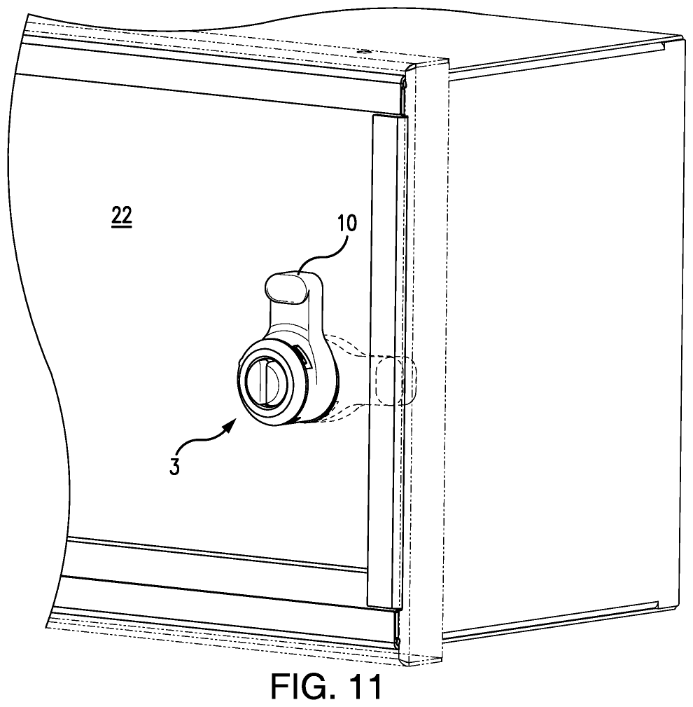

FIG. 11 is an illustration of a device of this invention installed in a door panel showing the latch 3, the door 22 and the latch extension 10.

What is claimed is:

1. A quarter turn twist lock door latch, said quarter turn twist lock door latch comprising in combination:
A. a latch having a front opening, a center core, a cross slot in a front of said center core, and a latch extension extending from said latch;
said latch having a back edge, said latch having a lock block mounted on said back edge, said lock being insertable in said opening of said latch and turnable therein;
B. a lock for said latch;
C. a rubber O-ring surrounding said center core at a distal end of said center core.
